(19) United States
(12) Patent Application Publication
(10) Pub. No.: US 2019/0080265 A1
(43) Pub. Date: Mar. 14, 2019

(54) SHARING SYSTEM OF VEHICLE AND ON-VEHICLE DEVICE MOUNTED ON VEHICLE

(71) Applicant: DENSO CORPORATION, Kariya-city, Aichi-pref. (JP)

(72) Inventor: Hiroshige ASADA, Kariya-city (JP)

(21) Appl. No.: 16/083,631

(22) PCT Filed: Mar. 2, 2017
(86) PCT No.: PCT/JP2017/008350

§ 371 Date: Sep. 10, 2018

(30) Foreign Application Priority Data
Mar. 16, 2016 (JP) 2016-052749

(51) Int. Cl. G06Q 10/02; G06Q 50/30; G07F 17/00; H04M 11/00

(52) U.S. Cl. CPC G06Q 10/02; H04M 11/00; G07F 17/0057; G06Q 50/30

(57) ABSTRACT

A sharing system of a vehicle using a portable phone includes an on-vehicle device mounted on the vehicle, and a server. In cases that a call connection request which designates the on-vehicle device as a transmission destination is transmitted from the portable phone, the server transfers the call connection request to the on-vehicle device. The on-vehicle device enables the vehicle to travel in response to receiving the call connection request transferred by the server.

### CROSS REFERENCE TO RELATED APPLICATION

The present application is based on Japanese Patent Application No. 2016-52749 filed on Mar. 16, 2016, the disclosure of which is incorporated herein by reference.

### TECHNICAL FIELD

The present disclosure relates to a sharing system of a vehicle, and an on-vehicle device mounted on a vehicle.

### BACKGROUND ART

There is conventionally known a system of sharing a vehicle; in the system, a portable phone held by a user communicates with a server so as to achieve a record, a fee collection, and an authentication for a use of the vehicle. For example, Patent literature 1 describes a system in which a user makes a phone call to a head office using their portable phone and inputs the number of a designated bicycle. The head office is provided with a computer corresponding to the server. Upon receiving the phone call to obtain the number of the designated bicycle, the computer transmits an unlock signal to a bicycle rental store so as to unlock the designated bicycle while starting a time measurement for a fee collection. The bicycle rental store unlocks the designated bicycle based on the unlocked signal. This enables the bicycle to travel.

### PRIOR ART LITERATURES

### Patent Literature

Patent literature 1: JP 2002-140763 A

### SUMMARY OF INVENTION

The inventor's study of (i) the communication between a portable phone and a server and (ii) the enablement of the travel of a vehicle due to the communication has found that the conventional technology poses an issue below. That is, the conventional technology requires the system to newly provide a server communicating with a portable phone of a user so as to enable a vehicle to travel. This increases a working load for configuring the system.

It is an object of the present disclosure to reduce a working load in configuring (i) a function of the communication between a server and a portable phone and (ii) a function of enabling a vehicle to travel by the server.

According to an aspect of the present disclosure, a sharing system of a vehicle using a portable phone includes (i) an on-vehicle device mounted on the vehicle and (ii) a server. In cases that a call connection request which designates the on-vehicle device as a transmission destination is transmitted from the portable phone, the server is configured to transfer the call connection request to the on-vehicle device. The on-vehicle device is configured to enable the vehicle to travel in response to receiving the call connection request transferred by the server.

Further, according to another aspect of the present disclosure, an on-vehicle device is mounted on a vehicle and is configured to perform a telephone communication with a portable phone. The on-vehicle device includes (i) a communicator unit configured to perform a telephone communication with the portable phone, and (ii) a controller unit. The controller unit is configured to enable the vehicle to travel in response to receiving a call connection request of which a transmission source is the portable phone via the communicator unit.

As such, the portable phone transmits a call connection request designating, as a transmission destination, the on-vehicle device instead of the server; the on-vehicle device enables the vehicle to travel based on a reception of the call connection request. Therefore, a function of communication between a portable phone and a server, and a function of enabling a vehicle to travel can be achieved by existing functions of telephone communication. This configuration reduces a working load in configuring the system.

### BRIEF DESCRIPTION OF DRAWINGS

FIG. 1 is a diagram illustrating a configuration of a bicycle sharing system;

FIG. 2 is a diagram illustrating a sequence of an operation at starting of a sharing;

FIG. 3 is a diagram illustrating a sequence of an operation at ending of a sharing;

FIG. 4 is a diagram illustrating a sequence of an operation of locking during a sharing;

FIG. 5 is a diagram illustrating a sequence of an operation of unlocking during a sharing; and

FIG. 6 is a diagram illustrating a configuration of a bicycle sharing system according to a first modification example.

### EMBODIMENTS FOR CARRYING OUT INVENTION

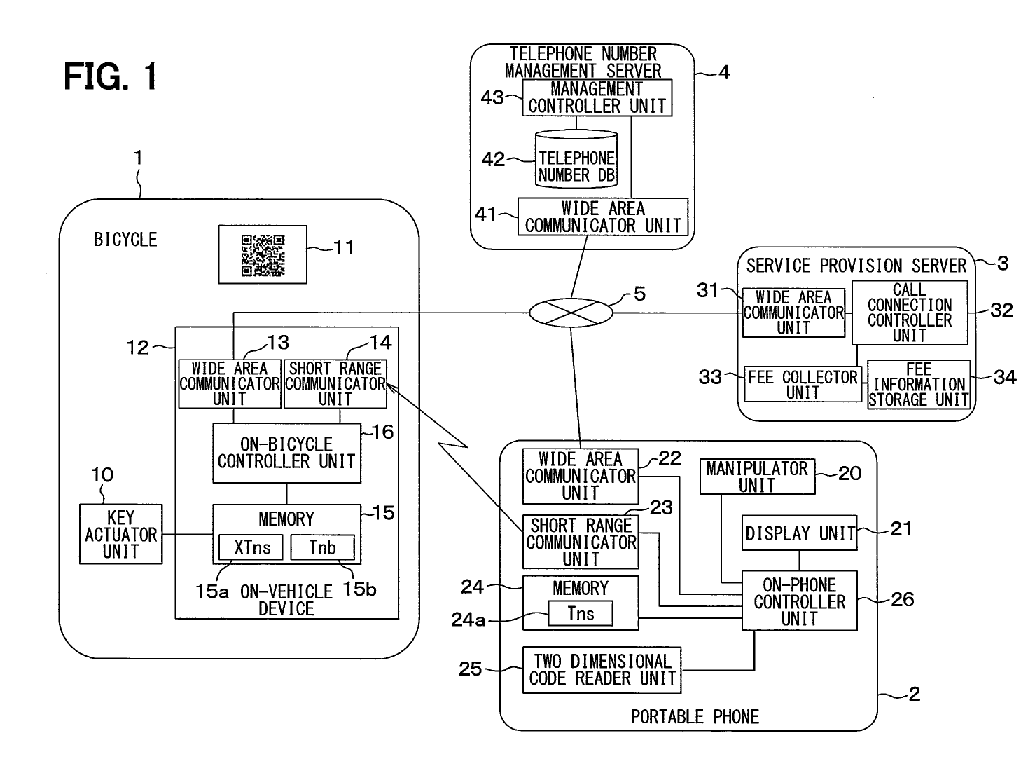

The following describes an embodiment. As illustrated in FIG. 1, a bicycle sharing system according to the present embodiment includes a bicycle 1, a portable phone 2, a service provision server 3, a telephone number management server 4, and a wide area network 5 (for example, the Internet, an IP phone network, a line switching network).

The bicycle 1 is owned by a sharing service provision operator, for example. The portable phone 2 is a smart phone which a user using the bicycle 1 holds. The service provision server 3 and the telephone number management server 4 are managed by a telephone business operator which provides a telephone service, for example.

In this bicycle sharing system, a user who holds the portable phone 2 borrows and uses the bicycle 1. The service provision server 3 performs a process of a fee collection for the use of the bicycle 1.

The bicycle 1 may be an electric assistant bicycle or may not be an electric assistant bicycle. The bicycle 1 includes a key actuator unit 10, a two dimensional code display medium 11, and an on-vehicle device 12.

The key actuator unit 10 is an apparatus (for example, electric motor) which actuates a key mechanism which switches a lock and an unlock of the bicycle 1. When the key mechanism locks the bicycle 1 according to the control by the key actuator unit 10, the bicycle 1 is disabled to travel. In contrast, when the key mechanism unlocks the bicycle 1 according to the control by the key actuator unit 10, the bicycle 1 is enabled to travel.

The two dimensional code display medium 11 is a medium such as paper on which a two dimensional code is illustrated. The two dimensional code display medium 11 is affixed onto the bicycle 1 so that a person can visually recognize the two dimensional code. The position of the affixing place of the two dimensional code display medium 11 is a position which the user easily reads using the portable phone 2. For example, the two dimensional code display medium 11 may be affixed onto a management number plate attached to the body of the bicycle 1.

The two dimensional code display medium 11 may be a sticker of which one side attached to the body of the bicycle 1 is applied with an adhesive. The two dimensional code indicated in the two dimensional code display medium 11 is a two-dimensional pattern indicating a telephone number Tnb of the on-vehicle device 12 and a parameter of a short range wireless connection. The two dimensional code may be a QR code, for example. The QR code is a registered trademark. The parameter of the short range wireless connection is the information of the on-vehicle device 12 that is necessary for the portable phone 2 to perform a short range wireless connection with the on-vehicle device 12.

The on-vehicle device 12, which is mounted in the bicycle 1, includes a wide area communicator unit 13, a short range communicator unit 14, a memory 15, and an on-bicycle controller unit 16. The wide area communicator unit 13 is a wireless communication interface to connect with a wide area network 5 via a wireless communication path etc., to communicate with the portable phone 2 and the service provision server 3 via the wide area network 5. The on-bicycle controller unit 16 can perform a telephone communication using the wide area communicator unit 13. The telephone communication may be performed based on a standard of a third generation mobile communication system, Long Term Evolution etc., for example.

The short range communicator unit 14 is a wireless communication module for performing a wireless communication directly with the portable phone 2. Performing the wireless communication directly signifies performing the wireless communication without any relay intervening. The short range communicator unit 14 provides a communication range having a 10 meter radius centering on the short range communicator unit 14, for example. The short range communicator unit 14 has a short range wireless communication mode as a communication mode. The short range wireless communication mode includes an IEEE-802.15.1 known as Bluetooth, for example. Bluetooth is a registered trademark. When the IEEE-802.15.1 is used, the parameter of the short range wireless connection indicated by the above-mentioned two dimensional code may be a parameter necessary in order that the portable phone 2 and the on-vehicle device 12 perform pairing, for example. Such a parameter may be a MAC address of the short range communicator unit 14, or a Bluetooth ID of the short range communicator unit 14, for example.

The memory 15 is a nonvolatile storage medium which stores a variety of data. This memory 15 includes an XTns storage unit 15a and a Tnb storage unit 15b. The XTns storage unit 15a is a unit of storing a telephone number received from an outside source. The Tnb storage unit 15b is a unit of storing previously the telephone number of the on-vehicle device 12 itself.

The on-bicycle controller unit 16 includes a CPU, RAM, ROM, etc.; the CPU executes programs recorded in the ROM while using the RAM as a work region.

The portable phone 2 is a phone carried by a user who uses the bicycle 1. The portable phone 2 includes a manipulator unit 20, a display unit 21, a wide area communicator unit 22, a short range communicator unit 23, a memory 24, a two dimensional code reader unit 25, and an on-phone controller unit 26.

The manipulator unit 20, which is a member for receiving directly a user's manipulation, includes a mechanical button and a touch panel. The display unit 21 includes an image display apparatus for displaying an image or a character and a sound output apparatus for outputting a speech.

The wide area communicator unit 22 is a wireless communication interface to connect with a wide area network 5 via a wireless communication path etc., to communicate with the on-vehicle device 12 and the service provision server 3 via the wide area network 5. The on-phone controller unit 26 can perform a telephone communication using the short range communicator unit 23.

The short range communicator unit 23 is a wireless communication module for performing a wireless communication directly with the on-vehicle device 12 in the bicycle 1. The short range communicator unit 23 provides a communication range having a 10 meter radius centering on the short range communicator unit 23, for example. The short range communicator unit 23 has the above short range wireless communication mode as a communication mode.

The memory 24 is a nonvolatile storage medium which stores a variety of data. This memory 15 includes a Tns storage unit 24a. The Tns storage unit 24a is a unit of storing previously the telephone number of the portable phone 2 itself.

The two dimensional code reader unit 25 is an apparatus for reading a two dimensional code. The two dimensional code reader unit 25 may be a camera which captures an image of a two dimensional code, for example. The on-phone controller unit 26 includes a CPU, RAM, ROM, etc.; the CPU executes programs recorded in the ROM while using the RAM as a work region.

The service provision server 3 includes a wide area communicator unit 31, a call connection controller unit 32, a fee collector unit 33, and a fee information storage unit 34. The wide area communicator unit 31 is a wireless communication interface to connect with a wide area network 5 via a wireless communication path etc., to communicate with the on-vehicle device 12, the portable phone 2, and the telephone number management server 4 via the wide area network 5.

The call connection controller unit 32 controls an establishment of a call between the on-vehicle device 12 and the portable phone 2 and a disconnection of the call, according to a predetermined call control protocol (for example, SIP). SIP is an abbreviation for Session Initiation Protocol. Therefore, the call connection controller unit 32 may be an SIP server. The call connection controller unit 32 includes a CPU, RAM, ROM, flash memory, etc.; the CPU executes programs recorded in the ROM or flash memory while using the RAM or flash memory as a work region. Such a process by the CPU achieves the above function of the call connection controller unit 32. In the flash memory of the call connection controller unit 32, a telephone number of the on-vehicle device 12 etc. is registered.

The fee collector unit 33 performs a fee collection with respect to a use of the bicycle 1. The fee collector unit 33 includes a CPU, RAM, ROM, flash memory, etc.; the CPU executes programs recorded in the ROM or flash memory while using the RAM or flash memory as a work region. Such a process by the CPU achieves the above function of the fee collector unit 33.

The fee information storage unit 34 is a non-volatile storage medium. In the fee information storage unit 34, the fee information is previously recorded. In the fee information, the name, an address, a settlement method, an account for settlement, etc. with respect to a user who is enabled to use the bicycle 1 are associated with the telephone number of the user's portable phone 2.

The telephone number management server 4 is a server which manages the registration of a telephone number. The telephone number management server 4 includes a wide area communicator unit 41, a telephone number DB 42, and a management controller unit 43. The wide area communicator unit 41 is a wireless communication interface to connect with a wide area network 5 via a wireless communication path etc., to communicate with the service provision server 3 via the wide area network 5.

The telephone number DB 42 is a database including a storage medium in which the telephone number of a portable phone of a specific user is registered. The specified user is a user who wishes to use a service of a bicycle sharing system at the time of making a telephone line contract of a portable phone 2. This portable phone 2 is a portable phone of the specific user. Therefore, the telephone number of the portable phone 2 is also previously registered in the telephone number DB 42. This registration is performed at the time of making the telephone line contract of the portable phone 2, for example.

The management controller unit 43 includes a CPU, RAM, ROM, flash memory, etc.; the CPU executes programs recorded in the ROM or flash memory while using the RAM or flash memory as a work region.

An operation of the bicycle sharing system having the above configuration will be explained. The following explains, in order, a sharing start at starting a sharing when a user borrows the bicycle 1, a sharing end at ending the sharing when the user returns the bicycle 1 (that is, return), locking during the sharing, and unlocking during the sharing.

(1) Sharing Start

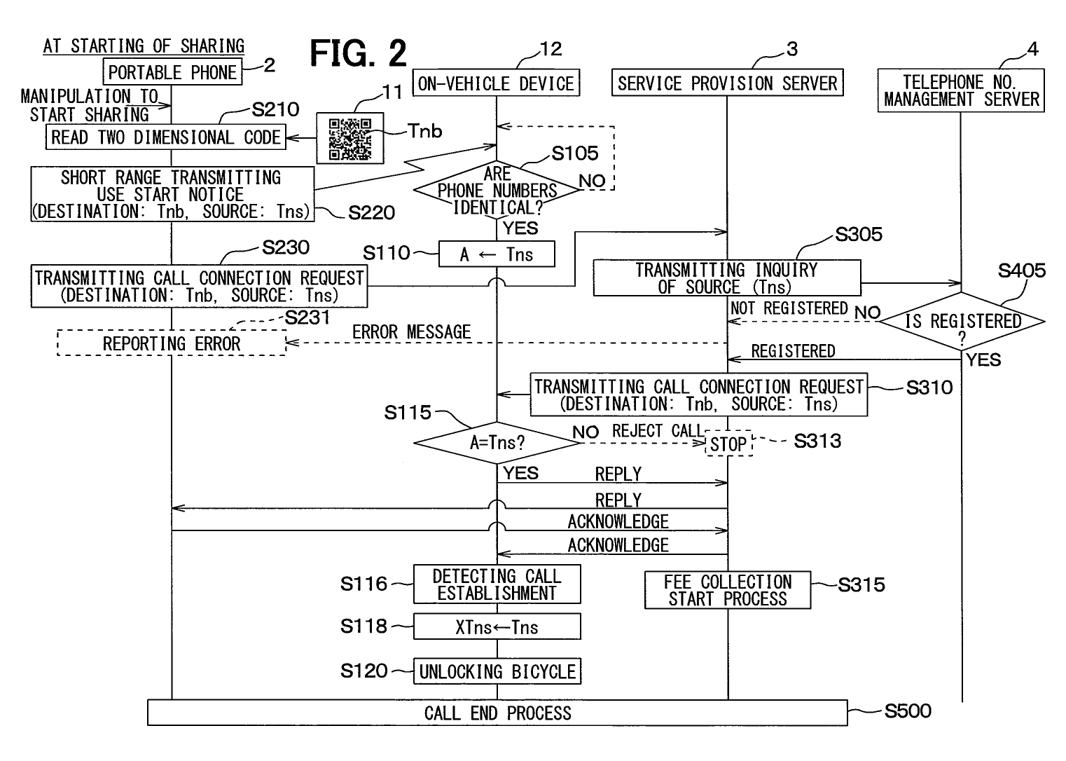

The process at a sharing start of starting sharing is explained using FIG. 2. First, a user who carries a portable phone 2 approaches a bicycle 1 to borrow. This permits the on-vehicle device 12 and the portable phone 2 to communicate with each other in a short range wireless communication mode. The user then makes the portable phone 2 read the two dimensional code displayed on the two dimensional code display medium 11.

In detail, the user performs a predetermined manipulation for a sharing start to the manipulator unit 20, then bringing the two dimensional code reader unit 25 close to the two dimensional code display medium 11. In response to that the manipulation for the sharing start is performed, at Step S210, the on-phone controller unit 26 reads out a pattern of the two dimensional code on the two dimensional code display medium 11 using the two dimensional code reader unit 25. Furthermore, at Step S210, the on-phone controller unit 26 decodes the read pattern in accordance with a predetermined rule. Such decoding provides a telephone number Tnb of the on-vehicle device 12, and a parameter of the short range wireless connection. Thus, attaching a two dimensional code display medium 11 to a bicycle 1 makes easier a telephone call from the portable phone 2 to the on-vehicle device 12 and the connection of the short range wireless communication.

Then, at Step S220, the on-phone controller unit 26 transmits a use start notice that is a notice of use start to the on-vehicle device 12 using the short range communicator unit 23. This use start notice contains a telephone number Tnb as a transmission destination telephone number, a telephone number Tns as a transmission source telephone number, and a start command as a command. This telephone number Tns is the telephone number read from the Tns storage unit 24a of the memory 24. In addition, the telephone number Tnb is the telephone number acquired at immediately previous Step S210.

Then, the on-bicycle controller unit 16 in the on-vehicle device 12 receives the use start notice via the short range communicator unit 14. In response to that the start command is contained in the received use start notice, the on-bicycle controller unit 16 proceeds to Step S105. At Step S105, the on-bicycle controller unit 16 determines whether the telephone number recorded in the Tnb storage unit 15b of the memory 15 is identical to the transmission destination telephone number contained in the use start notice received immediately before. When it is determined that they are not identical to each other, the use start notice is disregarded. This procedure reduces a possibility of performing an incorrect operation based on the use start notice which is transmitted to a different on-vehicle device (for example, transmitted to an on-vehicle device of a different bicycle near the bicycle 1). Such incorrect operation is to unlock and start a fee collection, which will be mentioned later.

In the present instance, those two telephone numbers are identical to each other. At Step S105, it is determined that the two telephone numbers are identical to each other; the sequence proceeds to Step S110. At Step S110, the transmission source telephone number Tns contained in the use start notice received immediately before is stored on a variable A in the memory 15.

In contrast, at Step S230 subsequent to Step S220, the on-phone controller unit 26 makes a telephone call to the on-vehicle device 12. In detail, the on-phone controller unit 26 transmits a call connection request (that is, Invite) using the wide area communicator unit 13. This call connection request is referred to as a first call connection request. This call connection request contains a transmission destination telephone number and a transmission source telephone number. This transmission destination telephone number is the telephone number Tnb of the on-vehicle device 12 acquired at previous Step S210. In addition, the transmission source telephone number is the telephone number Tns of the portable phone 2 read from the Tns storage unit 24a.

This call connection request arrives at the service provision server 3 via the wide area network 5 according to a usual call control protocol. This is because the telephone number Tnb of the on-vehicle device 12 is registered in the call connection controller unit 32 in the service provision server 3.

The call connection controller unit 32 in the service provision server 3 receives the call connection request via the wide area communicator unit 31. The call connection controller unit 32, which receives the call connection request, proceeds to Step S305 in response to that the transmission destination telephone number Tnb contained in the received call connection request is identical to the registered telephone number Tnb. At Step S305, the call connection controller unit 32 transmits an inquiry of a transmission source to the telephone number management server 4 using the wide area communicator unit 31. This inquiry of the transmission source contains the transmission source telephone number Tns contained in the call connection request received immediately before.

The management controller unit 43 in the telephone number management server 4 receives the inquiry of the transmission source via the wide area communicator unit 41. At Step S405, the management controller unit 43 which receives the inquiry of the transmission source determines whether the transmission source telephone number Tns contained in the inquiry of the transmission source is registered in the telephone number DB 42. When it is determined that it is not registered, the management controller unit 43 transmits a message which indicates an absence of the registration to the service provision server 3 using the wide area communicator unit 41.

In the present instance, the telephone number Tns of the portable phone 2 is registered in the telephone number DB 42 as already explained. The management controller unit 43 thus determines at Step S405 that it is registered; based on such determination, the management controller unit 43 transmits a message which indicates a presence of the registration to the service provision server 3 using the wide area communicator unit 41.

In contrast, suppose a case where the call connection controller unit 32 in the service provision server 3 transmits the inquiry of the transmission source at Step S305 and then receives the message which indicates an absence of the registration from the telephone number management server 4. In such a case, the call connection controller unit 32 transmits an error message to the portable phone 2 using the wide area communicator unit 31.

The on-phone controller unit 26 in the portable phone 2 receives the error message via the wide area communicator unit 22. Upon receiving the error message, at Step S231, the on-phone controller unit 26 reports an error to the user via the display unit 21. In this case, the lock of the bicycle 1 is not released, and any process for starting a fee collection is not performed, either.

In the present instance, after transmitting the inquiry of the transmission source at Step S305, the call connection controller unit 32 receives the message which indicates a presence of the registration from the telephone number management server 4 via the wide area communicator unit 31. At Step S310, upon receiving the message, the call connection controller unit 32 transmits a call connection request of which a transmission destination is the on-vehicle device 12 via the wide area communicator unit 31 according to a call control protocol. The on-vehicle device 12 is designated as a transmission destination since a transmission destination telephone number contained in the call connection request received immediately before is the telephone number Tnb of the on-vehicle device 12. The call connection controller unit 32 thus transfers the call connection request in response to that the telephone number Tns is registered. This procedure achieves an authentication using the telephone number of the portable phone.

This call connection request contains the transmission destination telephone number and the transmission source telephone number that are identical to those in the call connection request received immediately before. This signifies that, at Step S310, the call connection controller unit 32 transfers the call connection request received immediately before to the on-vehicle device 12.

Then, the on-bicycle controller unit 16 in the on-vehicle device 12 receives the call connection request via the wide area communicator unit 13. At Step S115, upon receiving the call connection request, the on-bicycle controller unit 16 determines whether the transmission source telephone number Tns contained in the received call connection request is identical to the value of the variable A.

In the present instance, the value of this transmission source telephone number Tns is identical to the variable A. Based on this, the on-bicycle controller unit 16 transmits a reply (that is, 200 OK) to the service provision server 3 via the wide area communicator unit 13. The call connection controller unit 32 receives this reply via the wide area communicator unit 31; based on having received the reply, the call connection controller unit 32 transmits the same reply to the portable phone 2 via the wide area communicator unit 31. That is, this reply arrives at the portable phone 2 from the on-vehicle device 12 via the service provision server 3.

Upon receiving this reply via the wire area communicator unit 22, the on-phone controller unit 26 transmits an acknowledgement (that is, Ack) to the service provision server 3 via the wide area communicator unit 22. The call connection controller unit 32 receives this acknowledgement via the wide area communicator unit 31; based on having received the acknowledge, the call connection controller unit 32 transmits the same acknowledgement to the on-vehicle device 12 via the wide area communicator unit 31. That is, this acknowledge arrives at the on-vehicle device 12 from the portable phone 2 via the service provision server 3. Based on having received this acknowledgement via the wide area communicator unit 13, at Step S116, the on-bicycle controller unit 16 in the on-vehicle device 12 detects that the call is established. This configuration establishes the call corresponding to the call connection request transmitted at Step S230 between the portable phone 2 and the on-vehicle device 12, starting a telephone communication between the portable phone 2 and the on-vehicle device 12.

At Step S118 subsequent to Step S116, the on-bicycle controller unit 16 records the telephone number of the opponent of the telephone communication in the XTns storage unit 15a as a password XTns. The telephone number of the opponent of the telephone communication is the transmission source telephone number Tns contained in the call connection request received immediately before. This configuration enables the telephone number of the portable phone to be used as a password for an authentication to be later.

Then, at Step S120, the on-bicycle controller unit 16 controls the key actuator unit 10 so as to unlock the bicycle 1 with the key mechanism. This configuration enables the user of the portable phone 2 to use the bicycle 1.

Further, upon detecting the call being established as mentioned above, the fee collector unit 33 in the service provision server 3 performs, at Step S315, a fee collection start process to start a fee collection. This fee collection start process records a sharing starting date and time in the flash memory in the fee information storage unit 34 to be associated with the transmission source telephone number Tns contained in the call connection request received immediately before. Thus, in response to that the telephone number Tns of the portable phone 2 is registered, the fee collection is performed while the use of a vehicle is permitted; thus, the use of a vehicle and the fee collection, which are surely associated with each other, are performed.

Then, the on-vehicle device 12, the portable phone 2, and the service provision server 3 perform a well-known call end process according to a call control protocol. In detail, a disconnect signal (that is, Bye) is transmitted from the on-vehicle device 12 via the wide area network 5. This disconnect signal is then relayed by the service provision server 3, and arrives at the portable phone 2. Upon receiving this disconnect signal, the portable phone 2 transmits a reply (that is, 200 OK) to the disconnect signal. This reply is relayed by the service provision server 3, and arrives at the on-vehicle device 12. This configuration disconnects the call corresponding to the call connection request transmitted at Step S230.

Unlike the present instance, suppose a case where a user, who carries the portable phone 2, uses the bicycle 1 at a previous time and then makes a telephone call to the telephone number of the on-vehicle device 12 mistakenly from a position distant from the bicycle 1. In such a case, the bicycle 1 is positioned to be distant from the portable phone 2; thus, the use start notice transmitted at Step S220 cannot be received by the on-vehicle device 12. The telephone number Tns of the portable phone 2 is thereby not stored in the variable A.

Then, the processing at Step S230, Step S305, Step S405, and Step S310 are performed similarly. However, the on-bicycle controller unit 16 in the on-vehicle device 12 determines at Step S115 that the transmission source telephone number Tns contained in the call connection request received immediately before is not identical to the value of the variable A.

In this case, the on-bicycle controller unit 16 transmits an incoming call rejection to the service provision server 3 via the wide area communicator unit 13. At Step S313, upon receiving the incoming call rejection, the call connection controller unit 32 in the service provision server 3 interrupts the process for a call connection. The telephone communication between the portable phone 2 and the on-vehicle device 12 thus fails to start. In this case, the lock of the bicycle 1 is not unlocked, and any process for starting a fee collection is not performed, either.

The above configuration can prevent incorrect unlocking or incorrect fee collection even if the user who carries the portable phone 2 makes a telephone call to the telephone number of the on-vehicle device 12 incorrectly from a remote place.

(2) Sharing End

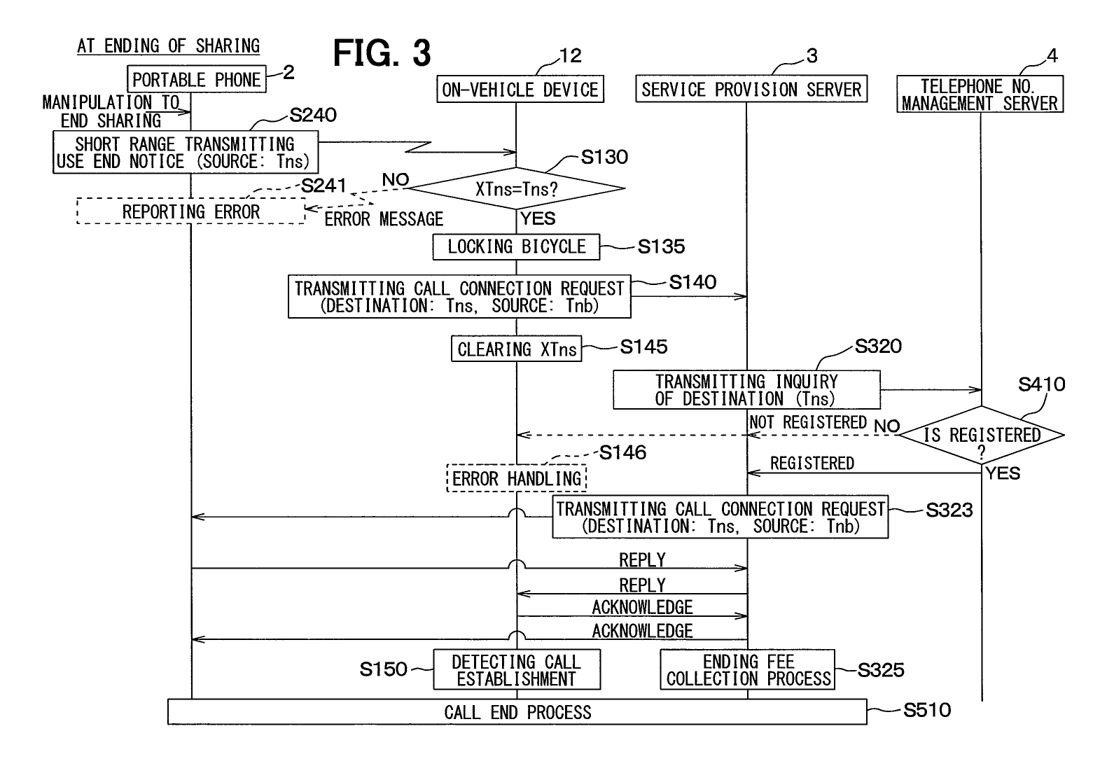

Next, the process at a sharing end of ending sharing is explained using FIG. 3. The user who uses the bicycle 1 puts the bicycle 1 in a predetermined bicycle stand. At this time, the user is adjacent to the bicycle 1. The portable phone 2 held by the user can communicate with the on-vehicle device 12 in the short range wireless communication mode.

At this time, the user performs a predetermined sharing end manipulation to the portable phone 2. In response to that the above sharing end manipulation is performed, at Step S240, the on-phone controller unit 26 transmits a sharing end notice that is a notice of sharing end to the on-vehicle device 12 using the short range communicator unit 14. This sharing end notice contains the telephone number Tns as a transmission source telephone number and an end command as a command. This telephone number Tns is the telephone number read from the Tns storage unit 24a in the memory 24.

Then, the on-bicycle controller unit 16 in the on-vehicle device 12 receives the use end notice via the short range communicator unit 14. In response to that the end command is contained in the received the use end notice, the on-bicycle controller unit 16 proceeds to Step S130. At Step S130, the on-bicycle controller unit 16 determines whether the password XTns recorded in the XTns storage unit 15a in the memory 15 is identical to the destination telephone number Tns contained in the use end notice received immediately before. In the present instance, it is determined that both are identical to each other, the sequence proceeds to Step S135. It is because the telephone number Tns of the portable phone 2 is recorded as the password XTns at starting of the sharing.

Suppose a case where it is determined that both telephone numbers are not identical to each other at Step S130. In such a case, the user of the portable phone 2 may not during sharing the bicycle 1, for example. In cases that it is determined that both telephone numbers are not identical to each other, the on-bicycle controller unit 16 transmits an error message to a portable phone serving as the transmission source of the use end notice (for example, the portable phone 2) via the short range communicator unit 14.

For instance, suppose a case where the on-phone controller unit 26 in the portable phone 2 receives the error message via the short range communicator unit 23. In such a case, at Step S241, the on-phone controller unit 26 reports an error to the user via the display unit 21. In this case, the lock of the bicycle 1 is not performed, and any process for ending a fee collection is not performed, either. This configuration reduces a possibility of performing an incorrect operation based on the use end notice which is transmitted from a different portable phone that is unauthorized. This incorrect operation is to lock and end a fee collection, which will be mentioned later.

Then, returning to the present instance, at Step S135, the on-bicycle controller unit 16 controls the key actuator unit 10 so as to lock the bicycle 1 with the key mechanism. The bicycle 1 is thereby caused to transition to a state of being disabled to be used. This configuration enables the telephone number of the portable phone to be used as a password for the sharing end.

Then, at Step S140, the on-bicycle controller unit 16 makes a telephone call to the portable phone 2. In detail, the on-bicycle controller unit 16 in the on-vehicle device 12 transmits a call connection request via the wide area communicator unit 13. This call connection request is referred to as a second call connection request.

This call connection request contains a transmission destination telephone number and a transmission source telephone number. The source telephone number is the telephone number Tnb of the on-vehicle device 12 read from the Tnb storage unit 15b. The transmission source telephone number is the transmission source telephone number Tns contained in the call connection request received immediately before.

At subsequent Step S145, the on-bicycle controller unit 16 clears the value of the password XTns in the XTns storage unit 15a. The value (that is, telephone number Tns) of the password XTns is thereby rewritten to a predetermined value (for example, zero). This can prevent a situation in which after ending the sharing of the bicycle 1 by the user of the portable phone 2, the portable phone 2 is still enabled to perform locking and unlocking under the sharing, to be mentioned later.

The call connection controller unit 32 in the service provision server 3 receives the call connection request which is transmitted at Step S140 via the wide area communicator unit 31. Upon receiving the call connection request, the call connection controller unit 32 proceeds to Step S320 in response to that the destination telephone number Tns contained in the received call connection request is not identical to the registered telephone number Tnb. At Step S320, the call connection controller unit 32 transmits an inquiry of a transmission destination to the telephone number management server 4 via the wide area communicator unit 31. This inquiry of the transmission destination contains the transmission destination telephone number Tns contained in the call connection request received immediately before.

The management controller unit 43 in the telephone number management server 4 receives the inquiry of the transmission destination via the wide area communicator unit 41. At subsequent Step S410, the management controller unit 43 which receives the inquiry of the transmission destination determines whether the destination telephone number Tns contained in the inquiry of the transmission destination is registered in the telephone number DB 42. In response to that it is not registered, the management controller unit 43 transmits a message which indicates an absence of the registration to the service provision server 3 via the wide area communicator unit 41.

In the present instance, the telephone number Tns of the portable phone 2 is registered in the telephone number DB 42 as already explained. The management controller unit 43 thus determines at Step S410 that it is registered; based on such determination, the management controller unit 43 transmits a message which indicates a presence of the registration to the service provision server 3 via the wide area communicator unit 41.

In contrast, suppose a case where the call connection controller unit 32 in the service provision server 3 transmits the inquiry of the transmission destination at Step S320 and then receives the message which indicates an absence of the registration from the telephone number management server 4. In such a case, the call connection controller unit 32 transmits an error message to the on-vehicle device 12 via the wide area communicator unit 31.

The on-bicycle controller unit 16 in the on-vehicle device 12 receives the error message via the wide area communicator unit 22. Upon receiving the error message, at Step S146, the on-bicycle controller unit 16 performs an error handling. The error handling may transmit an error message to the portable phone 2 via the short range communicator unit 14, for example. In this case, the on-phone controller unit 26 in the portable phone 2 receives this error message via the short range communicator unit 23, and reports an error to the user via the display unit 21.

In the present instance, after transmitting the inquiry of the transmission source at Step S320, the call connection controller unit 32 receives the message which indicates a presence of the registration from the telephone number management server 4 via the wide area communicator unit 31. At Step S323, the call connection controller unit 32, which receives it, transmits a call connection request of which a transmission destination is the portable phone 2 via the wide area communicator unit 31 according to a call control protocol. This configuration achieves an authentication at ending the sharing. The portable phone 2 is designated as a transmission destination since a transmission destination telephone number contained in the call connection request received immediately before is the telephone number Tns of the portable phone 2.

The call connection request contains the transmission destination telephone number and the transmission source telephone number that are identical to those in the call connection request received from the call connection controller unit 32 immediately before. This signifies that, at Step S323, the call connection controller unit 32 transfers the call connection request received immediately before to the portable phone 2.

This call connection request contains the transmission destination telephone number and the transmission source telephone number. The transmission destination telephone number is the transmission destination telephone number Tns contained in the call connection request received immediately before. The transmission source telephone number is the transmission source telephone number Tnb contained in the call connection request received immediately before.

The on-phone controller unit 26 in the portable phone 2 receives the call connection request via the wide area communicator unit 22. Based on this, the on-phone controller unit 26 transmits a reply (that is, 200 OK) to the service provision server 3 via the wide area communicator unit 22. The call connection controller unit 32 receives this reply via the wide area communicator unit 31; based on having received it, the call connection controller unit 32 transmits the same reply to the on-vehicle device 12 via the wide area communicator unit 31. That is, this reply arrives at the on-vehicle device 12 from the portable phone 2 via the service provision server 3.

Upon receiving this reply via the wire area communicator unit 13, the on-bicycle controller unit 16 in the on-vehicle device 12 transmits an acknowledgement (that is, Ack) to the service provision server 3 via the wide area communicator unit 13. The call connection controller unit 32 receives this acknowledgement via the wide area communicator unit 31; based on having received it, the call connection controller unit 32 transmits the same acknowledgement to the portable phone 2 via the wide area communicator unit 31. That is, this acknowledge arrives at the portable phone from the on-vehicle device 12 via the service provision server 3. Based on having transmitted this acknowledgement, at Step S150, the on-bicycle controller unit 16 detects that the call is established. This configuration establishes the call corresponding to the call connection request transmitted at Step S140 between the portable phone 2 and the on-vehicle device 12, starting a telephone communication between the portable phone 2 and the on-vehicle device 12.

In addition, in response to that the call connection controller unit 32 receives and then transmits the acknowledgement, at Step S325, the fee collector unit 33 in the service provision server 3 performs a fee collection end process to ending the fee collection. This achieves a fee collection end process at ending the sharing. This fee collection end process reads a sharing starting date and time in the flash memory in the fee information storage unit 34; the sharing starting date and time are associated with the transmission destination telephone number Tns contained in the call connection request received immediately before. The fee collector unit 33 calculates an elapsed time from the sharing starting date and time to the present time. Based on the calculated elapsed time, an amount of the fee collection is determined. The fee collector unit 33 reads a settlement method and an account for settlement, which are associated with the telephone number Tns, from the fee information storage unit 34. The fee collector unit 33 collects the use fee of the bicycle 1 by the calculated amount of the fee collection from the account of the settlement with the settlement method.

Then, the on-vehicle device 12, the portable phone 2, and the service provision server 3 perform a well-known call end process according to a call control protocol. In detail, a disconnect signal (that is, Bye) is transmitted from the on-vehicle device 12 via the wide area network 5. This disconnect signal is relayed by the service provision server 3, and arrives at the portable phone 2. Upon receiving the disconnect signal, the portable phone 2 transmits a reply (that is, 200 O.K.) to the disconnect signal. This reply is relayed by the service provision server 3, and arrives at the on-vehicle device 12. The call is thereby disconnected.

(3) Locking During Sharing

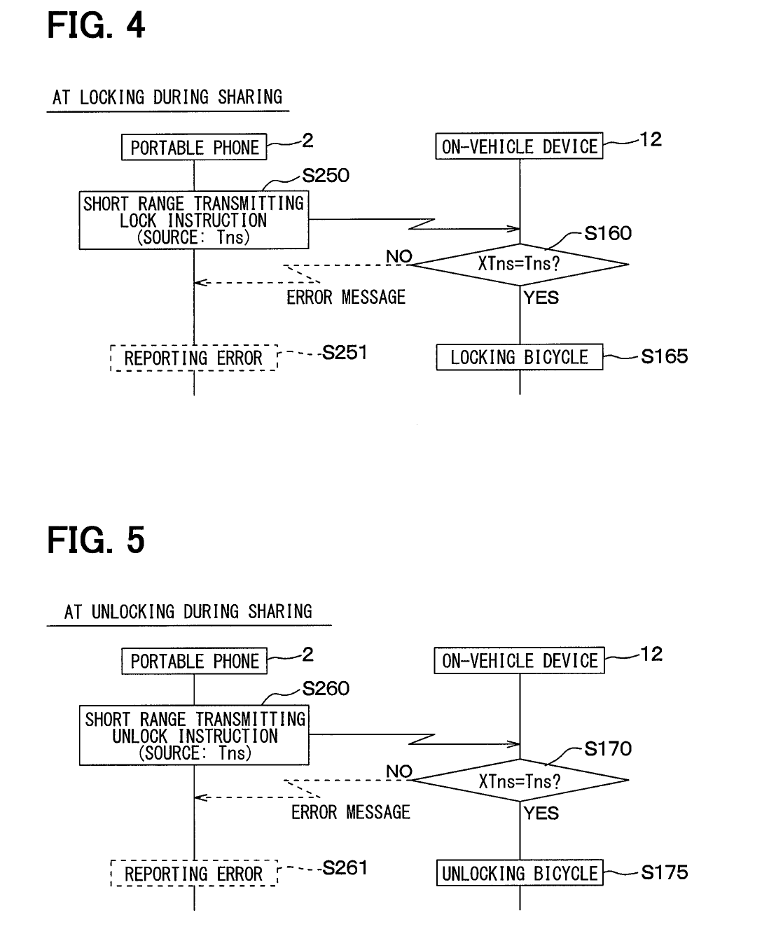

The following explains a process at locking in a period of time from the sharing start to the sharing end (that is, during the sharing) with reference to FIG. 4. The user who uses the bicycle 1 gets off the bicycle 1. At this time, the user is adjacent to the bicycle 1. The portable phone 2 which the user carries can communicate with the on-vehicle device 12 in the short range wireless communication mode.

At this time, the user performs a predetermined lock manipulation to the portable phone 2. In response to that the above lock manipulation is performed, at Step S250, the on-phone controller unit 26 transmits a lock instruction to the on-vehicle device 12 via the short range communicator unit 14. This lock instruction contains the telephone number Tns as a transmission source telephone number and the key lock command as a command. This telephone number Tns is the telephone number read from the Tns storage unit 24a in the memory 24.

Then, the on-bicycle controller unit 16 in the on-vehicle device 12 receives the lock instruction via the short range communicator unit 14. In response to that the key lock command is contained in the received lock instruction, the on-bicycle controller unit 16 proceeds to Step S160.

At Step S160, the on-bicycle controller unit 16 determines whether the transmission source telephone number Tns contained in the lock instruction received immediately before is identical to the password XTns recorded in the XTns storage unit 15a of the memory 15. In the present instance, both are identical to each other. It is because the telephone number Tns of the portable phone 2 is recorded in the XTns storage unit 15a as a password XTns at Step S118 at the sharing start. At Step S160, the on-bicycle controller unit 16 determines that the two telephone numbers are identical to each other, the sequence proceeds to Step S165.

Suppose a case where it is determined that both telephone numbers are not identical to each other at Step S160. In such a case, the user of the portable phone 2 may not during sharing the bicycle 1, for example. In response to that it is determined that both telephone numbers are not identical to each other at Step S160, the on-bicycle controller unit 16 transmits an error message to a portable phone of the transmission source of the lock instruction (for example, portable phone 2) via the short range communicator unit 14.

For instance, suppose a case where the on-phone controller unit 26 in the portable phone 2 receives the error message via the short range communicator unit 23. In this case, at Step S251, the on-phone controller unit 26 reports an error to the user via the display unit 21. In this case, the bicycle 1 is not locked. This configuration reduces a possibility of performing an incorrect lock operation based on the use end notice which is transmitted from a different portable phone that is unauthorized.

Then, returning to the present instance, at Step S165, the on-bicycle controller unit 16 controls the key actuator unit 10 so as to lock the bicycle 1 with the key mechanism. This causes the bicycle 1 to transition to a state of being disabled to be used. The user who carries the portable phone 2 can then separate from the bicycle 1 and acts. For example, while leaving the bicycle 1 at that position, the user can walk around on foot.

This configuration enables the telephone number of the portable phone to be used as a password for locking during the sharing.

(4) Unlocking During Sharing

The following explains a process at unlocking during a sharing after locking during the sharing, with reference to FIG. 5. After locking the bicycle 1, the user separates from the bicycle 1 and acts. Thereafter, while carrying the portable phone 2, the user returns to be located adjacent to the bicycle 1. At this time, the portable phone 2 which the user carries can communicate with the on-vehicle device 12 in the short range wireless communication mode.

At this time, the user performs a predetermined unlock manipulation to the portable phone 2. In response to that the above unlock manipulation is performed, at Step S260, the on-phone controller unit 26 transmits an unlock instruction to the on-vehicle device 12 via the short range communicator unit 14. This unlock instruction contains the telephone number Tns as a transmission source telephone number and the key unlock command as a command. This telephone number Tns is the telephone number read from the Tns storage unit 24a in the memory 24.

Then, the on-bicycle controller unit 16 in the on-vehicle device 12 receives the unlock instruction via the short range communicator unit 14. In response to that the key unlock command is contained in the received unlock instruction, the on-bicycle controller unit 16 proceeds to Step S170.

At Step S170, the on-bicycle controller unit 16 determines whether the transmission source telephone number Tns contained in the unlock instruction received immediately before is identical to the password XTns recorded in the XTns storage unit 15a in the memory 15. In the present instance, both are identical to each other. It is because the telephone number Tns of the portable phone 2 is recorded in the XTns storage unit 15a as a password XTns at Step S118 at the sharing start. At Step S170, the on-bicycle controller unit 16 determines that the two telephone numbers are identical to each other, the sequence proceeds to Step S175.

Suppose a case where it is determined that both telephone numbers are not identical to each other at Step S170. In such a case, the user of the portable phone 2 may not during sharing the bicycle 1, for example. In response to that it is determined that both telephone numbers are not identical to each other at Step S170, the on-bicycle controller unit 16 transmits an error message to a portable phone of the transmission source of the unlock instruction (for example, the portable phone 2) via the short range communicator unit 14.

For instance, the on-phone controller unit 26 in the portable phone 2 receives the error message via the short range communicator unit 23. In this case, at Step S261, the on-phone controller unit 26 reports an error to the user via the display unit 21. In this case, the bicycle 1 is not unlocked. This configuration reduces a possibility of performing an incorrect unlock operation based on the use end notice which is transmitted from a different portable phone that is unauthorized.

Then, returning to the present instance, at Step S175, the on-bicycle controller unit 16 controls the key actuator unit 10 so as to unlock the bicycle 1 with the key mechanism. The bicycle 1 is thereby caused to transition to a state of being enabled to be used. Then, the user who carries the portable phone 2 restarts the use of the bicycle 1.

This configuration enables the telephone number of the portable phone to be used as a password for unlocking during the sharing.

As explained above, when the call connection request of which the transmission destination is the on-vehicle device 12 is transmitted from the portable phone 2, the service provision server 3 transfers the call connection request to the on-vehicle device 12. The on-vehicle device 12 then enables the bicycle 1 to travel based on reception of the call connection request transferred by the service provision server 3.

As such, the portable phone 2 transmits a call connection request designating, as a transmission destination, the on-vehicle device 12 instead of the service provision server 3; the on-vehicle device 12 enables the bicycle 1 to travel based on a reception of the call connection request. Therefore, a function of communication between a portable phone and a server, and a function of enabling a vehicle to travel can be achieved by existing functions of telephone communication. This reduces a working load for configuring the system.

In addition, the work which unlocks the bicycle 1 via the service provision server 3 only requires the portable phone 2 to make a telephone call to the telephone number of the on-vehicle device 12. This eliminates a complicated work which inputs the number of the bicycle after making a telephone call to the telephone number of the head office like in Patent literature 1.

It is noted that in the above embodiment, a storage medium or any memory is a non-transitory tangible storage medium.

### OTHER EMBODIMENTS

The present disclosure is not limited to the above-mentioned embodiment, and can be modified suitably. In addition, in the above embodiment, a constituent element is not necessarily indispensable, unless otherwise explicitly indicated or believed to be indispensable theoretically. In addition, in the above embodiment, a numerical value such as the number of constituent elements, an amount, a value, or a range of each constituent element, is not necessarily limited to a specified numerical value, unless otherwise explicitly indicated or theoretically limited to the specified numerical value. In particular, in cases where a certain amount is exemplified as any one of several values, a value between the several values may be adopted, unless otherwise particularly negated or theoretically impossible. In addition, in the above embodiment, a shape or positional relation of each constituent element is not limited to a specified shape or positional relation, unless otherwise explicitly indicated or theoretically limited to the specified shape or positional relation. In addition, the present disclosure may permit the following modification examples or modification examples within an equivalent. It is noted that the respective modification examples below may be selectively employed or not employed. That is, any combination of the following modification examples except for a combination clearly posing contradiction may be applied to the above embodiment.

### First Modification Example

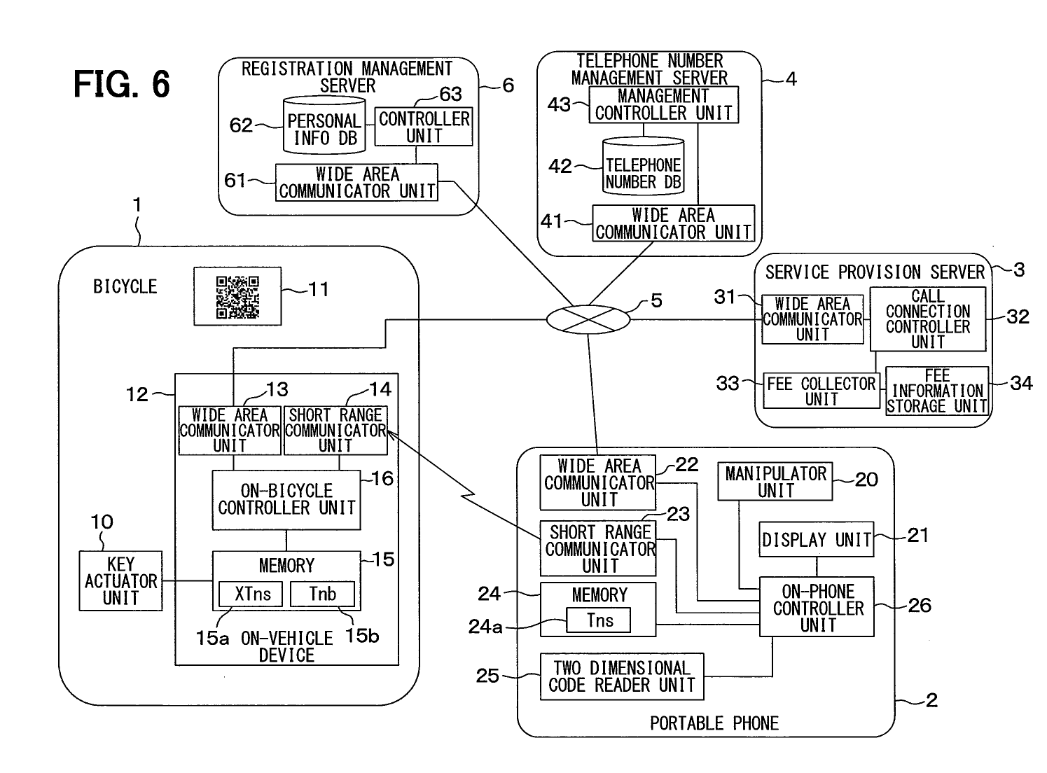

The bicycle sharing system according to the above embodiment may additionally include a registration management server 6, as illustrated in FIG. 6. The registration management server 6 is a server different from the service provision server 3. The registration management server 6 may be possessed or managed by a telephone business operator which provides a telephone service. Alternatively, the registration management server 6 may be possessed or managed by the sharing service provision operator.

The registration management server 6 includes a wide area communicator unit 61, a personal information DB 62, and a controller unit 63. The wide area communicator unit 61 is a wireless communication interface to connect with a wide area network 5 via a wireless communication path etc., to communicate with the service provision server 3 etc.

The personal information DB 62 is a database containing a storage medium in which the personal information of an authorized user who is enabled to use the bicycle 1 is registered. In the personal information, a name, an address, a settlement method, an account for settlement, etc. with respect to a user who is enabled to use the bicycle 1 are associated with a telephone number of the user's portable phone 2. The information recorded in the personal information DB 62 is equivalent to the information recorded in the fee information storage unit 34.

It is noted that the personal information in the personal information DB 62 may be registered by the sharing service provision operator when a pre-contract of the bicycle sharing service is made, instead of when a telephone line contract is made. In this case, the controller unit 63 in the registration management server 6 may transmit the registered personal information to the service provision server 3 via the wide area communicator unit 61. In that case, the fee collector unit 33 in the service provision server 3 performs additional recording of the personal information received via the wide area communicator unit 31 into the fee information storage unit 34.

This personal information in the personal information DB 62 may be accessed and acquired by the sharing service provision operator. Such a configuration enables the sharing service provision operator to perform a reservation of the bicycle sharing, a notice of the use status of a bicycle for sharing, or a countermeasure for a stolen ride of a bicycle.

### Second Modification Example

The above embodiment describes a target of the sharing to be one bicycle. There may however be two or more bicycles as the target of the sharing. In that case, each of two or more of bicycles includes an on-vehicle device having a function identical to that of the on-vehicle device 12. The telephone numbers of two or more of on-vehicle devices are different from each other.

### Third Modification Example

The above embodiment describes a target of the sharing to be a bicycle 1. The target of the sharing may however be a motorcycle or a four-wheel vehicle. That is, the on-vehicle device 12 may be mounted on any one of kinds of vehicles.

### Fourth Modification Example

In the above embodiment, the function of the call connection controller unit 32 and the function of the fee collector unit 33 are performed within the same single service provision server 3. The function of the fee collector unit 33 may however be achieved by a different apparatus for the fee collection other than the service provision server 3. In that case, at Step S315, the call connection controller unit 32 performs a notice process to transmit a notice to the different apparatus for the fee collection, the notice instructing the different apparatus to perform the fee collection start process. This notice process is a process for the fee collection. Further, at Step S325, the call connection controller unit 32 performs a notice process to transmit a notice to the different apparatus for the fee collection end process, the notice instructing the different apparatus to perform the fee collection end process. This notice process is also a process for the fee collection.

### Fifth Modification Example

Under the above embodiment, when receiving a call connection request of which the transmission destination is the portable phone 2 from the on-vehicle device 12 at the sharing end, the service provision server 3 makes an inquiry at Step S320 whether a presence or absence of the registration of the telephone number of the portable phone 2. When subsequently receiving a message which indicates a presence of the registration, the service provision server 3 transmits a call connection request to the portable phone 2. This enables the establishment of the call corresponding to the call connection request. In response to the establishment of the call, the service provision server 3 performs a fee collection end process while the on-vehicle device 12 locks the bicycle 1.

The portable phone 2 may however transmit the call connection request at the sharing end. In detail, upon receiving a call connection request which designates the on-vehicle device 12 as a transmission destination and is transmitted from the portable phone 2, the service provision server 3 makes an inquiry whether there is a presence or an absence of the registration of the telephone number of the portable phone 2, to the telephone number management server 4. When subsequently receiving a message which indicates a presence of the registration from the telephone number management server 4, the service provision server 3 transmits the call connection request to the on-vehicle device 12. This enables the establishment of the call corresponding to the call connection request. Based on the establishment of the call, the service provision server 3 performs a fee collection end process while the on-vehicle device 12 locks the bicycle 1. In this case, the call connection request transmitted from the portable phone 2 is referred to as a second call connection request.

According to the above embodiment and the present modification example, upon receiving from one of the on-vehicle device 12 and the portable phone 2 a call connection request which designates the other one of the on-vehicle device 12 and the portable phone 2 as a transmission destination, the service provision server 3 makes an inquiry whether there is a presence or an absence of the registration of the telephone number of the portable phone 2, to the telephone number management server 4. When subsequently receiving a message which indicates a presence of the registration from the telephone number management server 4, the service provision server 3 transmits the call connection request to the other one of the on-vehicle device 12 and the portable phone 2. This enables the establishment of the call corresponding to the call connection request. Based on the establishment of the call, the service provision server 3 performs a fee collection end process while the on-vehicle device 12 locks the bicycle 1. In this case, the call connection request transmitted from the portable phone 2 is referred to as a second call connection request.

### Sixth Modification Example

In addition, the above fifth modification example may be subjected to the following modification. First, when the user performs a sharing end manipulation to the manipulator unit 20 in the portable phone 2, the on-phone controller unit 26 makes a telephone call to the on-vehicle device 12, without transmitting a use end notice to the on-vehicle device 12 via the wide area communicator unit 22. In this case, in response to that the call is established, the on-bicycle controller unit 16 in the on-vehicle device 12 determines whether the transmission source telephone number contained in the call connection request received immediately before is identical to the password XTns. Only when both are identical to each other, the value of the password XTns is cleared while the key actuator unit 10 is controlled to lock the bicycle 1 with the key mechanism.

### Seventh Modification Example

In the above embodiment, the portable phone 2 and the on-vehicle device 12 communicate with each other in the short range wireless communication mode. This communication mode may employ an encryption for exchanging the telephone number Tns, Tnb to enhance the security.

### Eighth Modification Example

In the above embodiment, the on-vehicle device 12 employs the telephone number Tns of the portable phone 2 as a password XTns. The on-vehicle device 12 may employ, in addition to the telephone number Tns of the portable phone 2, a clock time when the portable phone 2 transmits the call connection request at the sharing start as a password XTns.

In this case, the on-phone controller unit 26 records, in the memory 24, the clock time when transmitting the call connection request at the sharing start. In response to that the call is established, the on-vehicle device 12 is notified of the clock time via the wide area communicator unit 13 or the short range communicator unit 14. The on-bicycle controller unit 16 records, at Step S118, the information on the result of combining the telephone number Tns of the portable phone 2 and the clock time, as a password XTns in the Tnb storage unit 15b.

At the sharing end, the on-phone controller unit 26 transmits, at Step S240, the above clock time recorded in the memory 15 to the on-vehicle device 12 in addition to the telephone number Tns of the portable phone 2. The on-bicycle controller unit 16 in the on-vehicle device 12 then combines the clock time with the received telephone number Tns, and determines at Step S130 whether the password XTns is identical to the information on the combined result.

Further, at locking during the sharing, at Step S250, the on-phone controller unit 26 transmits the above clock time recorded in the memory 15 to the on-vehicle device 12 in addition to the telephone number Tns of the portable phone 2. The on-bicycle controller unit 16 in the on-vehicle device 12 then combines the clock time with the received telephone number Tns, and determines at Step S160 whether the password XTns is identical to the information on the combined result.

Further, at unlocking during the sharing, at Step S260, the on-phone controller unit 26 transmits the above clock time recorded in the memory 15 to the on-vehicle device 12 in addition to the telephone number Tns of the portable phone 2. The on-bicycle controller unit 16 in the on-vehicle device 12 then combines the clock time with the received telephone number Tns, and determines at Step S170 whether the password XTns is identical to the information on the combined result. This enhances the security.

### Ninth Modification Example

At the sharing start of the above embodiment and at the sharing end in the above fifth and sixth modifications, in response to the establishment of the call of the telephone communication between the portable phone 2 and the on-vehicle device 12, the on-bicycle controller unit 16 may turn on a headlight attached to the bicycle 1 or an LED dedicated for notice to emit light. This enhances the user interface.

### Tenth Modification Example

In the above embodiment, an SIP is exemplified as a call control protocol. The call control protocol other than the SIP may be employed. For example, H.225 may be employed.

### Eleventh Modification Example

When determining a fee amount, at Step S325, the fee collector unit 33 in the service provision server 3 may transmit the fee amount to the portable phone 2 via the wide area communicator unit 31. In that case, the on-phone controller unit 26 in the portable phone 2 receives the fee amount via the wide area communicator unit 22, and displays the received fee amount in the display unit 21.

### Twelfth Modification Example

In the above embodiment, at Step S118 at the sharing start, the on-bicycle controller unit 16 stores the transmission source telephone number Tns contained in the call connection request received immediately before in the XTns storage unit 15a. However, the telephone number Tns itself may be not needed to be stored; instead, a message digest of the telephone number Tns may be stored. That is, any data corresponding to the telephone number Tns may be stored as a password XTns in the XTns storage unit 15a. Naturally, the telephone number Tns itself is an example of the data corresponding to the telephone number Tns.

Similarly, at Step S130 at the sharing end, the on-bicycle controller unit 16 only needs to determine whether the password XTns corresponds to the transmission source telephone number Tns contained in the use end notice received immediately before.

Similarly, at Step S160 at locking during the sharing, the on-bicycle controller unit 16 only needs to determine whether the password XTns corresponds to the transmission source telephone number Tns contained in the lock instruction received immediately before.

Similarly, at Step S170 at unlocking during the sharing, the on-bicycle controller unit 16 only needs to determine whether the password XTns corresponds to the transmission source telephone number Tns contained in the unlock instruction received immediately before.

### Thirteenth Modification Example

In the above embodiment, the portable phone 2 acquires the telephone number of the on-vehicle device 12, and the parameter of the short range wireless connection by reading the two dimensional code. Another method may be employed to acquire the telephone number of the on-vehicle device 12, and the parameter of short range wireless connection. For example, the user may manually input the telephone number of the on-vehicle device 12, and the parameter of short range wireless connection to the portable phone 2.

### Fourteen Modification Example

In the above embodiment, Bluetooth is exemplified as an example of the short range wireless communication mode. However, NFC (for example, FeliCa) may be used as a short range wireless communication mode. NFC is an abbreviated name for Near Field Communication. FeliCa is a registered trademark. When NFC is employed, the mutual telephone numbers are exchanged simultaneously when the portable phone 2 contacts the on-vehicle device 12.

### Fifteen Modification Example

In the above embodiment, the call connection request transmitted from the portable phone 2 or the service provision server 3 is a call connection request when making a telephone call to the opponent. The call connection request transmitted from the portable phone 2 or the service provision server 3 may be a call connection request when transmitting an SMS. SMS is an abbreviated name for the short message service. SMS is a communication performed on the line switching network. In this case, an SMS message is equivalent to a call connection request. The service provision server 3 includes a function of a short message service center.

### SUMMARY

According to a first aspect described in part or entity of each embodiment, in response to a call connection request which designates an on-vehicle device as a transmission destination is transmitted from a portable phone, a server transfers the call connection request to the on-vehicle device. The on-vehicle device enables a vehicle to travel based on reception of the call connection request transferred by the server.

In addition, according to a second aspect, in response to that the call connection request which designates the on-vehicle device as a transmission destination is transmitted from the portable phone, the server makes an inquiry whether the telephone number of the portable phone is registered, and, if registered, transfers the call connection request to the on-vehicle device. This configuration can achieve an authentication using the telephone number of the portable phone.

In addition, according to a third aspect, in response to that a call corresponding to the call connection request is established, the server performs a process of a fee collection using the telephone number of the portable phone. Thus, in response to that the telephone number of the portable phone is registered, the fee collection is performed while the use of the vehicle is permitted; thus, the use of the vehicle and the fee collection are surely performed to be associated with each other.

In addition, according to a fourth aspect, a display medium attached to the vehicle expresses a code that the portable phone is enabled to read; and the code indicates the telephone number of the on-vehicle device. Such a display medium is attached to the vehicle; this facilitates a telephone call from the portable phone to the on-vehicle device.

In addition, according to a fifth aspect, in response to that the telephone number of the portable phone is received from the portable phone wirelessly without a relay intervening, the on-vehicle device stores the telephone number on a variable A in a memory. When receiving the call connection request transferred by the server, the on-vehicle device enables the vehicle to travel in response to that the telephone number of the transmission source contained in the call connection request is identical to the value of the variable A. The above configuration can prevent the vehicle from being incorrectly enabled to travel even if the user who carries the portable phone makes a telephone call to the telephone number of the on-vehicle device incorrectly from a remote place.

In addition, according to a sixth aspect, in response to that the call corresponding to the call connection request is established, the on-vehicle device records a data corresponding to the telephone number of the transmission source contained in the call connection request as a password. This configuration enables the telephone number of the portable phone to be used as a password for an authentication to be later.

In addition, according to a seventh aspect, when receiving an unlock instruction, the on-vehicle device disables the vehicle to travel in response to that the telephone number contained in the lock instruction corresponds to the password. This configuration enables the telephone number of the portable phone to be used as a password for locking during the sharing.

In addition, according to an eighth aspect, when receiving an unlock instruction, in response to that the telephone number contained in the unlock instruction corresponds to the password, the on-vehicle device enables the bicycle to travel. This configuration enables the telephone number of the portable phone to be used as a password for locking during the sharing.

In addition, according to a ninth aspect, when receiving a use end notice, in response to that the telephone number contained in the use end notice corresponds to the password, the on-vehicle device clears the password while disabling the bicycle to travel.

This configuration enables the telephone number of the portable phone to be used as a password for ending the sharing. In addition, the password is cleared at this time. This configuration can prevent a situation where the portable phone can control to enable or disable the bicycle 1 after the sharing is ended.

In addition, according to a tenth aspect, a second call connection request has a transmission source that is a one of the portable phone and the on-vehicle device and a transmission destination that is a different one of the portable phone and the on-vehicle device. In response to that the second call connection request is transmitted, an inquiry whether the telephone number of the portable phone is registered is made. If registered, the second call connection request is transferred to the different one; in response to that a call corresponding to the second call connection request is established, a process of a fee collection using the telephone number of the portable phone is performed. This configuration can achieve an authentication and a fee collection at the time of ending the sharing.

In addition, according to an eleventh aspect, an on-vehicle device is mounted in a vehicle and performs telephone communication with a portable phone. The on-vehicle device includes a communicator unit for performing a telephone communication with the portable phone and a controller unit. The controller unit enables the vehicle to travel in response to that a call connection request of which a transmission source is the portable phone is received via the communicator unit.

What is claimed is:

1. A sharing system of a vehicle using a portable phone,
the sharing system comprising:
an on-vehicle device mounted on the vehicle; and
a server,
wherein:
in response to receiving a telephone number of the portable phone from the portable phone wirelessly without a relay intervening, the on-vehicle device is configured to store the telephone number on a variable in a memory;
in cases that a call connection request of which a transmission destination is the on-vehicle device is transmitted from the portable phone, the server is configured to transfer the call connection request to the on-vehicle device; and
in cases that the on-vehicle device receives the call connection request transferred by the server, the on-vehicle device is configured to enable the vehicle to travel in response to that a telephone number of a transmission source contained in the call connection request is identical to a value of the variable.

2. The sharing system according to claim 1, wherein:
in cases that a call connection request of which a transmission destination is the on-vehicle device is transmitted from the portable phone, the server is configured to make an inquiry whether the telephone number of the portable phone is registered; and
in response to that the telephone number is registered, the server is configured to transfer the call connection request to the on-vehicle device.

3. The sharing system according to claim 2, wherein
in response to that a call corresponding to the call connection request is established, the server is configured to perform a process of a fee collection using the telephone number of the portable phone.

4. The sharing system according to claim 1, wherein:
the vehicle is attached with a display medium;
the display medium is configured to express a code that the portable phone is enabled to read; and
the code is configured to indicate a telephone number of the on-vehicle device.

5. (canceled)

6. The sharing system according to claim 1, wherein
in response to that a call corresponding to the call connection request is established, the on-vehicle device is configured to record a data corresponding to the telephone number of the transmission source contained in the call connection request as a password.

7. The sharing system according to claim 6, wherein
in cases that the on-vehicle device receives a lock instruction, the on-vehicle device is configured to disable the vehicle to travel in response to that a telephone number contained in the lock instruction corresponds to the password.

8. The sharing system according to claim 6, wherein
in cases that the on-vehicle device receives an unlock instruction, the on-vehicle device is configured to enable the vehicle to travel in response to that a telephone number contained in the unlock instruction corresponds to the password.

9. The sharing system according to claim 6, wherein
in cases that the on-vehicle device receives a use end notice, the on-vehicle device is configured to disable the vehicle to travel and clear the password in response to that a telephone number contained in the use end notice corresponds to the password.

10. The sharing system according to claim 1, wherein:
the call connection request is referred to as a first call connection request;
a second call connection request has a transmission source that is a one of the portable phone and the on-vehicle device and a transmission destination that is a different one of the portable phone and the on-vehicle device;
in response to that the second call connection request is transmitted, the server is configured to make an inquiry whether a telephone number of the portable phone is registered;
if the telephone number of the portable phone is registered, the server is configured to transfer the second call connection request to the different one; and
in response to that a call corresponding to the second call connection request is established, the server is configured to perform a process of a fee collection using a telephone number of the portable phone.

11. An on-vehicle device which is mounted on a vehicle to perform telephone communicate with a portable phone,
the on-vehicle device comprising:
a communicator unit configured to perform a telephone communication with the portable phone; and
a controller unit,
wherein:
in response to receiving a telephone number of the portable phone from the portable phone wirelessly without a relay intervening, the controller unit is configured to store the telephone number on a variable in a memory; and
in cases that the controller unit receives a call connection request of which a transmission source is the portable phone via the communicator unit, the controller unit is configured to enable the vehicle to travel in response to that a telephone number of the transmission source contained in the call connection request is identical to a value of the variable in the memory.

12. An on-vehicle device which is mounted on a vehicle to perform telephone communicate with a portable phone,
the on-vehicle device comprising:
a communicator unit configured to perform a telephone communication with the portable phone; and
a controller unit,
wherein:
the controller unit is configured to enable the vehicle to travel in response to receiving a call connection request of which a transmission source is the portable phone via the communicator unit; and
in response to that a call corresponding to the call connection request is established, the controller unit is configured to record a data corresponding to a telephone number of the transmission source contained in the call connection request as a password.

13. A sharing system of a vehicle using a portable phone,
the sharing system comprising:
an on-vehicle device mounted on the vehicle; and
a server,
wherein:
in cases that a call connection request of which a transmission destination is the on-vehicle device is transmitted from the portable phone, the server is configured to transfer the call connection request to the on-vehicle device;
in response to receiving the call connection request transferred by the server, the on-vehicle device is configured to enable the vehicle to travel; and
in response to that a call corresponding to the call connection request is established, the on-vehicle device is configured to record a data corresponding to a telephone number of a transmission source contained in the call connection request as a password.

14. The sharing system according to claim 13, wherein:
in cases that the call connection request of which the transmission destination is the on-vehicle device is transmitted from the portable phone, the server is configured to make an inquiry whether a telephone number of the portable phone is registered; and
in response to that the telephone number is registered, the server is configured to transfer the call connection request to the on-vehicle device.

15. The sharing system according to claim 14, wherein
in response to that the call corresponding to the call connection request is established, the server is configured to perform a process of a fee collection using the telephone number of the portable phone.

16. The sharing system according to claim 13, wherein:
the vehicle is attached with a display medium;
the display medium is configured to express a code that the portable phone is enabled to read; and
the code is configured to indicate a telephone number of the on-vehicle device.

17. The sharing system according to claim 13, wherein
in cases that the on-vehicle device receives a lock instruction, the on-vehicle device is configured to disable the vehicle to travel in response to that a telephone number contained in the lock instruction corresponds to the password.

18. The sharing system according to claim 13, wherein
in cases that the on-vehicle device receives an unlock instruction, the on-vehicle device is configured to enable the vehicle to travel in response to that a telephone number contained in the unlock instruction corresponds to the password.

19. The sharing system according to claim 13, wherein
in cases that the on-vehicle device receives a use end notice, the on-vehicle device is configured to disable the vehicle to travel and clear the password in response to that a telephone number contained in the use end notice corresponds to the password.

20. A sharing system of a vehicle using a portable phone,
the sharing system comprising:
an on-vehicle device mounted on the vehicle; and
a server,
wherein:
in cases that a call connection request of which a transmission destination is the on-vehicle device is transmitted from the portable phone, the server is configured to transfer the call connection request to the on-vehicle device;
in response to receiving the call connection request transferred by the server, the on-vehicle device is configured to enable the vehicle to travel;
the call connection request is referred to as a first call connection request;
a second call connection request has a transmission source that is a one of the portable phone and the on-vehicle device and a transmission destination that is a different one of the portable phone and the on-vehicle device;
in response to that the second call connection request is transmitted, the server is configured to make an inquiry whether a telephone number of the portable phone is registered;
if the telephone number of the portable phone is registered, the server is configured to transfer the second call connection request to the different one; and
in response to that a call corresponding to the second call connection request is established, the server is configured to perform a process of a fee collection using the telephone number of the portable phone.
